(19) United States
(12) Patent Application Publication
(10) Pub. No.: US 2014/0044237 A1
(43) Pub. Date: Feb. 13, 2014

(54) Micro-gripper for Automated Sample Harvesting and Analysis

(71) Applicant: NATX-RAY, SAN DIEGO, CA (US)

(72) Inventors: Jean-Luc Ferrer, Corenc (FR); Mohammad Yaser Heidari Khajepour, Grenoble (FR); Nathalie Agnes Larive, La Jolla, CA (US); Xavier Vernede, Echirolles (FR)

(73) Assignee: COMMISSARIAT A L'ENERGIE ATOMIQUE ET AUX ENERGIES ALTERNATIVES, Paris (FR)

(21) Appl. No.: 13/960,805

(22) Filed: Aug. 7, 2013

Related U.S. Application Data
(60) Provisional application No. 61/680,849, filed on Aug. 8, 2012.

(51) Int. Cl. B25J 15/00; G01N 23/207; B25J 9/00

(52) U.S. Cl. CPC B25J 15/0028; B25J 9/00; G01N 23/2076
USPC 378/73; 294/86.4; 294/192; 414/729; 414/815

(57) ABSTRACT

The present invention relates to a micro-gripper comprising tweezers, designed to be used for the harvesting of fragile sub-millimeter samples from their production or storage medium. The tweezers may be equipped with removable soft ending elements to prevent the deterioration of the sample. When coupled to a robotic arm, this micro-gripper allows automated flow of operations in a continuous and automated process, from harvesting to sample preparation and analysis. The present invention is particularly used in X-ray crystallography.

### RELATED APPLICATION

Provisional Application No. 61/6808949 dated Aug. 8, 2012, “A Robotic Equipment for Automated Sample Harvesting and Analysis, using a 6-axis robot arm and a micro-gripper”, assigned to: COMMISSARIAT A L'ENERGIE ATOMIQUE ET AUX ENERGIES ALTERNATIVES; inventors: LARIVE Nathalie, FERRER Jean-Luc, VERNEDE Xavier, HEIDARI KHAJEPOUR Mohammad Yaser.

### BACKGROUND OF THE INVENTION

The resolution of protein structures by X-ray crystallography involves numerous steps. In the recent years, most of these steps such as protein purification (Kim et al., 2004, J. Struct. Funct. Genomics 5, 111-118), crystallization (Mueller-Dieckmann, 2006, Acta Cryst. D62, 1446-1452) and also data collection and processing have been mostly automated (Adams et al., 2011, Methods 55, 94-106; Ferrer, 2001, Acta Cryst. D57, 1752-1753; Manjasetty et al., 2008, Proteomics 8, 612-625). The critical step remains the harvesting of crystals from their crystallization drop, for crystals grown using the vapor diffusion method (McPherson, 1989, Preparation and analysis of protein crystals, Malabar, USA: Krieger Publishing Company), followed by the cryo-protection and freezing steps. These three steps are still performed manually, which is a real bottleneck to high-throughput crystallography and a limitation in the remote use of protein crystallography core facilities.

Due to their solvent content, ranging from 20% to more than 80%, protein crystals are very fragile and easily damaged due to variation of temperature and ambient humidity or mechanical stress. Considering also the small dimensions of protein crystals (from ˜10 μm to ˜500 μm), it is particularly difficult not to damage the crystal with manual harvesting. Furthermore with high throughput “nanodrops” crystallization robots mostly used nowadays, crystals grow even smaller, rather in the ˜5 μm to ˜50 μm range. In situ diffraction in the crystallization drop at room temperature is an alternative to crystal harvesting (Jacquamet et al., 2004, Structure 12, 1219-1225). Nevertheless because of limitations due to crystal symmetry and crystal degradation during beam exposure at room temperature, harvesting and freezing samples remain in many cases necessary.

Within the past few decades the most commonly used method to harvest protein crystals has been manual handling using micro loops (Teng, 1990, J. Appl. Cryst. 23, 387-391, and U.S. Pat. No. 8,210,057). Nowadays on high throughput protein crystallization setups, crystals are produced in micro to nano-litter drops dispensed with pipeting robots on 96-well microplates. Manipulating into these drops with micro-loops requires dexterity, due to the geometry of the microplates. Moreover, crystals are visualized through a binocular. Harvesting crystals in this configuration is very challenging since the microscope blocks an easy access to the drop. When the volume of crystallization drops is reduced, fast manipulation is mandatory to avoid drop evaporation. At the same time, manipulating crystals requires high delicacy and sharpness, especially when crystals are very small. Protein crystals with all their fragility have to be hanged in the loop liquid while taking out the loop from their crystallization drop. But crystals can be trapped in a skin at the surface of the drop, or stuck at the bottom of the well. In this last case, crystals are tapped to be removed from the bottom. In these difficult situations, manual harvesting stresses the crystal and could harm or even destroy the crystal. Thirdly, once the crystal is harvested on a loop it has to be transferred into a cryo-protecting solution before freezing (Parkina & Hope, 1998, J. Appl. Cryst. 31, 945-953). Consequently, in most cases, the crystal will be released into the cryo-protecting drop and it has to be harvested once again. All these manual operations increase the difficulty of the task and also the risk to damage the crystal even more. Finally, crystals must be flash-cooled to avoid ice formation (Kriminski et al., 2002, Acta Cryst., D58, 459-471) and kept at a temperature below 140 K (Garman & Schneider, 1997, J. Appl. Cryst. 30, 211-237). The most traditional methods are to immerse the loop into liquid nitrogen (77 K) or to expose the loop to a 100 K nitrogen gas stream. The reproducibility of these operations is quite random when performed manually (Warkentin et al., 2006, J. Appl. Cryst. 39, 805-811).

In addition to this, all the delicate steps described above are now to be performed at an increasing speed, because of the growing demand for protein crystallography data, especially for drug design. Therefore, automation and remote access to crystallography setups has become a strategic goal for laboratories, as illustrated by the emergence of beamlines coupled to crystallization platforms, or hig technology core facilities shared by several laboratories.

At least four different automated harvesting systems for protein crystals have been developed in the last decade:
1) one with a two-finger manipulator system (Ohara et al., 2004, Proceedings of the 2004 International Symposium on Micro-Nanomechatronics and Human Science, 301-306), using a loop, where the two-finger manipulator is used to push the sample into the loop inside the drop, the extraction of the sample from the drop being performed with the loop,
2) another with a traditional harvesting loop on a 6-axis robot arm (Viola et al., 2011, J. Struct. Funct. Genomics 12, 77-82),
3) the “Crystal Harvester”, that uses two motorized loops (BrukerAXS),
4) the last one consists in a series of micro-manipulators aimed at protein crystals seeding and a loop for harvesting (Georgiev et al., 2004, IEEERSJ International Conference on Intelligent Robots and Systems IROS; Vorobiev et al., 2006, Acta Cryst. D62, 1039-1045).

Even though these systems provide better accuracy and no vibration compared to human manipulation, they haven't been successful because of lack of reliability and compatibility issues to standard materials and procedures. Furthermore, none of these systems actually perform the harvesting, the preparation and the analysis of the samples using one single setup, with no need to transfer the samples to another setup.

Several examples of grippers used for sample handling exist in the literature. Specifically, a system using a gripper with soft-ending elements to manually handle cells in their medium has been described by Chronis and Lee (Chronis and Lee, 2005, Journal of MicroElectro Mechanical Systems, 14, 857-863). But none of these systems are used for the harvesting of fragile samples, such as protein crystals, because of the risk to break or deteriorate the sample upon extraction from its medium.

The simultaneous use of a robot for holding a protein crystal and positioning it in an X-ray beam, for example, has been reported in U.S. Pat. No. 6,408,047. But in such a system the sample is manually harvested, and mounted on a holder, prior to the automatic data collection operation.

It is an object of this invention to provide a micro-gripper comprising tweezers with an aperture range from 0 to 1 mm, designed to harvest sub millimeter samples, either manually or in an automated way, that is reliable and compatible with standard materials and procedure, and that can be directly used to position the sample for further analysis.

It is a further object of this invention to provide such a micro-gripper in which the tweezers are made of soft ending elements that prevent the deterioration of fragile samples such as protein crystals, these soft ending elements being either removable or permanent.

It is a further object of this invention to provide such a micro-gripper in conjunction with a robotic arm, used for the extraction, preparation and analysis of samples without releasing the samples between the different steps.

It is a further object of this invention to provide a method of performing crystallography experiments, comprising
a step of extracting a small sample from a medium using a gripper with tweezers, said gripper being mounted at the end of a robot arm or used manually
a step of sequential transfer of the sample to preparation
an optional step of preparation of said sample
a step of analysis (performing x-ray crystallography) the said extracted sample

In the method according to the invention, the sample is preferably not released between the different steps.

During the step of analysis, an X-ray beam may be used, the sample being positioned by the robot, after some preparation steps.

### BRIEF SUMMARY OF THE INVENTION

The present invention consists in a micro-gripper, with an aperture range from 0 to 1mm that is mounted on a robot arm, so that the sample can be transferred to different environments, in order to prepare it, and to present it to a specific setup for direct analysis. This merges in a unique way the “harvesting”, the “preparation” and the “analysis” operations. This gripper can be equipped, if required, with soft, removable, ending elements to handle samples as fragile as protein crystals. These ending elements are simple, easy to mount or dismount, which gives the possibility to adapt them to the type of samples to be manipulated.

All these operations start from a sample in its production or storage medium, with no need to pre-load the sample on a specific holder.

All these operations can be done manually, or remotely controlled by the user or even fully automated, depending on the difficulty to identify samples in their medium.

The present innovation is based on a highly flexible design. Indeed, the invention can be used:
in various fields of application, and therefore for various types and sizes of samples (small/medium molecule crystals or aggregates, macromolecule crystals or aggregates, quasi-crystals, partially ordered crystals, fibers, etc.), as well as various types of medium in which they are stored or produced (gel, liquid, dry support, etc.),
no matter the function to be accomplished for the preparation steps, when required, or the means to accomplish them (soaking, heating, cooling, freezing, exposure to electric/magnetic fields, etc.), and the analysis methods (diffusion, diffraction, absorption, spectroscopy, etc.),

the gripper can be a piezoelectric, mechanical, or thermoelectric actuator, but not limited to these elements. The ending elements, or jaws, when needed, can be made of a polymer, with a thickness from about 10 microns to about 100 microns. Choice of material can be SU-8, Kapton™, Mylar™, polyester, polystyrene, polyolefin film, but not limited to these. And the robot arm can be anything from a 3 to 7 axis, with cartesian, scara or anthropomorphic geometry.

### BRIEF DESCRIPTION OF THE SEVERAL VIEWS OF THE DRAWINGS

FIG. 1 is a schematic representation of the elements of the micro-gripper. This embodiment comprises an actuator 1 on which ending elements 2 are attached, in order to grab sub-millimeter size sample 3.

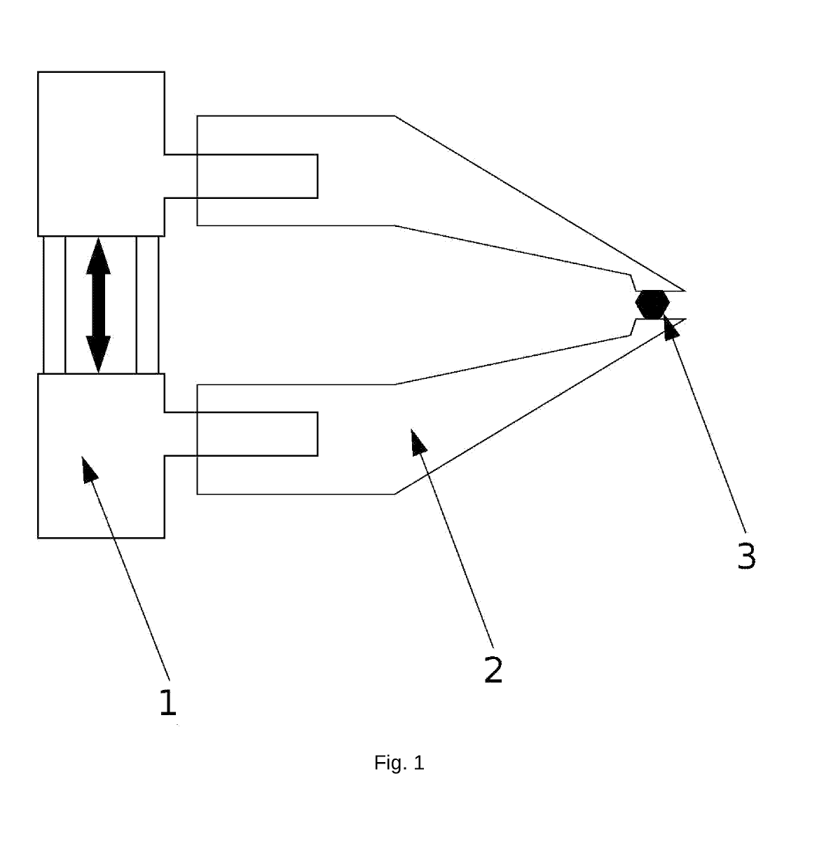

FIG. 2 is a schematic representation of an automated system made of a robotic arm equipped with the micro-gripper object of the invention, as shown during the sample harvesting operation. This embodiment comprises a robotic arm 4 equipped with the micro-gripper 5 (scaled up for a better understanding). The micro-gripper is presented while it grabs the sample 6 in its medium 7.

FIG. 3 is a schematic representation of an automated system made of a robotic arm equipped with the micro-gripper, as shown during the sample analysis operation. This embodiment comprises a robot arm 4 equipped with the micro-gripper 5 (scaled up for a better understanding). The gripper is presented while it handles the sample 6 for analysis, via the exposition into a X-ray beam for example 8.

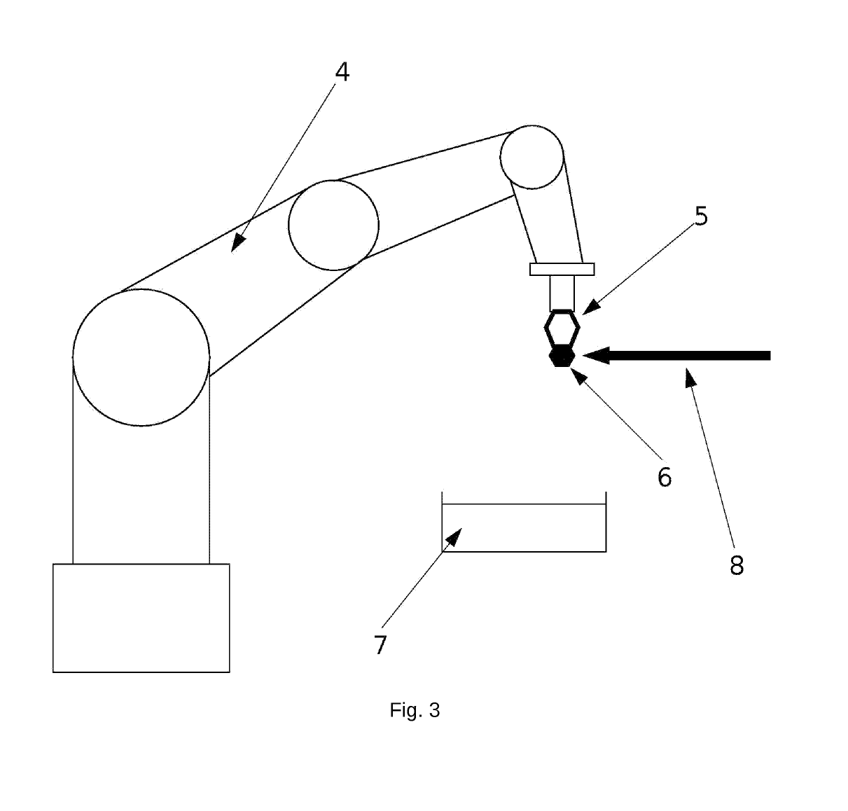

### DETAILED DESCRIPTION OF THE INVENTION

The present innovation is illustrated in the specific situation of protein crystallography. In such a situation, the sample is a protein crystal, the medium is the crystallization drop where the crystal has grown, the subsequent preparation steps are cryoprotection and freezing, and the analysis setup is a X-ray diffraction equipment. This system is a good example of the present innovation considering the specific challenging domain of protein crystallography. However, the innovation is not limited to this area, and only minor modifications of the overall system would be required to adapt it to a specific situation, the general layout of the robot arm equipped with a microgripper and ending elements remaining unchanged.

The embodiment of the present invention described here is a micro-gripping device equipped with tweezers and mounted on a robotic arm, that allows to perform crystal harvesting, cryo-protection and freezing in an automated or remotely-driven way. With this set-up, harvesting experiments were performed on several crystals, followed by direct data collection using the robot arm as a goniometer. Analysis of the diffraction data demonstrated that this system is highly reliable and efficient, and does not alter crystallography data. This is a surprising result, as gripping a protein crystal to move it through the surface of a drop has always been considered by experts in the field as extremely risky. Therefore, this new gripper provides the last step towards full automation of crystallography experiments and fills the gap of the high-throughput crystallography pipelines.

Surprisingly, it was found out that, contrary to what all the experts in crystallography thought, using proper tweezers to handle crystals did not break them. In the experiments presented here, a micro-gripper comprising tweezers from Percipio-Robotics, is used. Each finger of the tweezers has two degrees of freedom that are remotely controlled with a resolution of 1.0 μm and a reproducibility of 0.1 μm. By combining symmetrical translations of both piezo-electrical fingers, an opening gap range from 0 μm to 500 μm is obtained. The ending elements in contact with crystals are manufactured separately from the two-finger actuator. The material used for these ending elements is called SU-8 (Ling et al., 2009, Microsyst. Technol. 15, 429-435). SU-8 is known to produce a very low scattering background in X-ray. Comparing to other common materials used for the fabrication of crystal harvesting loops, the SU-8 shows a background scattering in X-ray exposure between Kapton™ and nylon. The ending elements geometry was designed to provide the best possible grip on crystals and the lowest volume of SU-8 exposed to the X-ray, in order to further minimize scattering for future data collection. We chose to reduce the thickness of the ending elements in order to bring enough flexibility to limit the stress on crystals. The level of reduced thickness appropriate to avoid breaking the crystals was totally unknown and never described or even imagined possible by the experts in the field. During the experiments, we realized that the thickness chosen when designing the ending elements quite surprisingly enabled us to actually grab the crystals without breaking them in the process.

### Materials and Methods

In the experiments, 14.4 kDa lysozyme protein from hen egg-white (Roche, Reference number: 10837059001) was crystallized by mixing 500 nL of a 50 mg/mL protein solution in 0.24% (w/w) acid acetic with 500 nL of 5% NaCl (w/v) reservoir solution. The 56.3 kDa NikA protein from E. coli was also used. Its cytoplasmic apo form was expressed and purified as previously described in Cherrier and coworkers (Cherrier et al., 2008, Biochemistry 47, 9937-9943). A 10 mg/mL apo-NikA solution was pre-incubated overnight at 4° C. with 2 molar equivalent of FeEDTA and this protein-ligand complex was crystallized by mixing 0.5 μL of this solution with 0.5 μL sodium acetate 0.1 M pH 4.7, ammonium sulfate 1.5 to 1.95 M reservoir solution (Cherrier et al., 2005, J. Am. Chem. Soc. 127, 10075-10082). Protein samples were crystallized on CrystalQuick™ X plates, a vapor diffusion sitting drop microplate (Bingel-Erlenmeyer et al., 2011, Cryst. Growth Des. 11, 916-923). CrystalQuick™ X has been developed especially for in situ screening by Greiner Bio-One and the FIP-BM30A group. CrystalQuick™ X is a SBS-standard 96-Well microplate plate, with two flat wells for sitting drops per reservoir. The geometry of this plate gives a better access to drops for crystal manipulation. Wells are 1.3 mm deep in CrystalQuick™ X plate, whereas other wells of other plates range from 3 mm to 4 mm deep.

In our experiment, plates were filled manually, after which they were screened for pairs of crystals grown in the same drop. For each pair, one of the two crystals was manually harvested, cryo-protected and flash-cooled using LithoLoops™ (from Molecular Dimensions) and the other one went through the same steps using the micro-gripper object of the present invention. Comparison between the two methods is described further.

Experiments were led on beamline FIP-BM30A (Roth et al., 2002, Acta Cryst. D58, 805-814) at the ESRF. This beamline uses a bending magnet as a source and delivers a monochromatic beam with an intensity of 5 e¹¹ photons/(0.3×0.3 mm²)/s for 2×10⁻⁴ energy resolution at 12.5 keV. In these experiments the beam size was defined at 0.2 mm×0.2 mm. An ADSC Q315r CCD detector was used for the recording of the diffraction frames. The goniometer used for these experiments was the G-Rob system, commercialized since 2009 by NatX-ray (www.natx-ray.com). G-Rob is a multi-task robotic system based on a Stäubli 6-axis robot arm, developed on beamline FIP-BM30A at the ESRF (Grenoble, France). G-Rob is accurate enough to operate as a goniometer (Jacquamet et al., 2009, J. Synchrotron Rad. 16, 14-21). It is able to collect X-ray diffraction data with a sphere of confusion smaller than 15 μm radius for frozen samples and capillaries. This setup is completed with a fully motorized visualization bench equipped with an inverted microscope and a three-direction motorized microplate holder.

On G-Rob, two motorized translations are installed at the end of the robot arm to center each sample on the 6th axis of the robot which is used as the spindle axis. In the following experiments, this centering operation is done only once, when G-Rob holds its micro-gripper tool before the harvesting operation. In so doing, once the crystal is transferred to the spindle position, it is already centered into the beam with a positioning error less than 10 μm. Thus X-ray diffraction data can be collected right away.

For these experiments the on-axis microscope is used to define the spindle position and to center the samples in the beam. The two centering translations on the robot arm were used to initially center the ending elements of the micro-gripper on the G-Rob spindle axis, or for the manual experiment, to center individually each harvested sample. For each sample, X-ray diffraction data were collected with 1° oscillation at 0.98 Å wavelength.

The experiment consisted in doing the harvesting manually, followed by data collection and analysis using the set-up available on FIP-BM30A beamline, and to compare that with the inventive method using the micro-gripper, followed by the same data collection and analysis as in the manual harvesting. In order to assess the impact of the stress inflicted on crystals with the micro-gripper, series of tests of harvesting, cryo-protection and flash-freezing were led manually and with the invention. With the invention, crystals are directly exposed in the X-ray beam (“direct data collection”) after being grabbed by the micro-gripper, in order to evaluate the gripping influence on crystals structure. Two pairs of crystals from the same wells of each protein were chosen and prepared for diffraction data collection with G-Rob, in both the manual and the invention (see Table 1 and 2).

In the manual method, crystals were visualized using a classical laboratory binocular and were manually harvested with SPINE standard loops (Hampton Research, reference number: HR8-124). Crystals were then soaked into the cryo-protecting solution (25% w/w Glycerol and reservoir solution) for about 20 to 30 seconds and flash-cooled into a 100 K temperature nitrogen gas stream generated by a Cryostream 700 system (Oxford Cryosystem).

In the present embodiment of the invention, crystallization plates were screened using an inverted microscope associated with a computer with a Graphical User Interface (GUI). In order to do that, a drop of the appropriate cryo-protecting solution is disposed over the crystallization drop. A button on the GUI enables to take the micro-gripper over the visualized well. The control of the robot and micro-gripper is enabled through the GUI and a game pad. Thanks to the 6-axis arm of the G-Rob, the micro-gripper is capable of three translations and two rotations movements. Furthermore the opening and closing control of the micro-gripper is integrated in the GUI and in the game pad buttons.

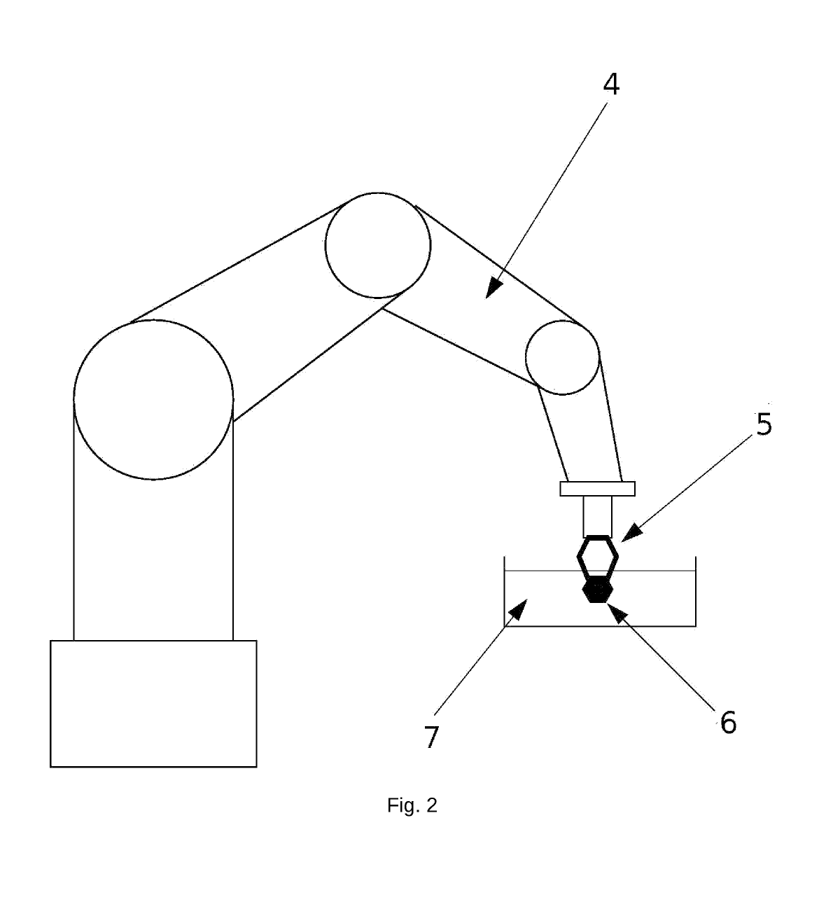

First, the motorized translations and zoom of the inverted microscope are used to center crystals in the microscope and to adjust the focus. Then the user drives the movements of the G-Rob arm to approach the micro-gripper to the crystals. The lights are also controlled with the GUI to optimize vision quality. Once the crystal is captured between the two SU-8 ending elements of the micro-gripper (FIG. 2), a button on the GUI transfers the crystal into the nitrogen gas stream with a fast, still safe trajectory to the spindle position. The trajectory of the robot in approach of the spindle position is programmed perpendicular to the 100 K stream with the robot's fastest speed to optimize the flash-freezing. The trajectory ends at a position where the crystal is already properly centered into the spindle position. Since the G-Rob does the goniometer task and the ending elements of the micro-gripper are transparent to X-ray, it is possible to proceed right away with data collection, without having to release the crystal and without the need for any human manipulation.

Diffraction data were processed using XDS (Kabsch, 2010, Acta Cryst. D66, 125-132) and scaled with SCALA (Evans, 2006, Acta Cryst. D62, 72-82) from CCP4 (CCP4, C.C.P.N 1994, Acta Cryst. D50, 760-763) or XSCALE from XDS. Phasing was performed by molecular replacement with PHASER (McCoy et al., 2007, J. of Applied Crystallogr. 40, 658-674) from CCP4 using 1LZ8 and 1ZLQ form Protein Data Bank (PDB) as starting models for lysozyme and NikA-FeEDTA, respectively. Refinement was performed using PHENIX (Adams et al., 2010, Acta Cryst. D66, 213-221). Root mean square deviation (RMSD) values were calculated on main chains using COOT (Emsley and Cowtan, 2004, Acta Cryst. D60, 2126-2132).

Comparative analysis of data reduction showed no significant differences in mosaicity, resolution limits and unit cell dimensions (Table 1). Unit cell volume comparisons of both manual and automated harvested samples (Table 2) also showed no significant difference. Nevertheless their comparison with PDB structures 1ZLQ and 1LZ8, respectively for NikA-FeEDTA and for lysozyme, showed variations from 1.4% to 3.6%. Diffraction data for lysozyme (PDB entry: 1LZ8) were collected at 120 K and not at 100 K. Thermal expansion cannot account for this difference. Indeed, calculations based on Tanaka, 2001, J. Mol. Liquids 90, 323-332, considering the crystal and solvent as water, show only 0.15% volume variation of each unit cell. Therefore the unit cell volume differences are due to the experimental setup discrepancy.

Data and refinement statistics are similar whatever the crystal harvesting method, robotic or manual. The RMSD values (Table 2) between the structures, based on main chain comparison, are weak and do not exceed 0.46 Å for both proteins. Thus, we can confirm that the stress on the crystals is controlled and that there is no structural rearrangement due to the use of the micro-gripper. Although it does not show in the data statistics, certainly due to the small number of crystals tested, there is a reduced amount of solvent around the crystal when harvested with the robot. It results in a reduced scattering. Indeed, the average background measured by XDS (INIT step), and normalized to 1 sec exposure time and 1 mA current in the ESRF ring, is 0.126 and 0.071 respectively for lysozyme and NikA-FeEDTA when crystals are harvested with the robot, whereas it is 0.154 and 0.174 when harvested manually.

For the experiments presented above, cryo-protectant was added to the drop prior to harvesting. The crystal held by the micro-gripper object of the invention can also be soaked into a cryo-protecting drop, without the need to release the crystal. The soaking time can be specified on the Graphical User Interface (GUI), so that the robot transfers the crystal to the spindle position automatically at the end of the soaking period.

### Advantage of the Invention

In the experiment using the invention, high accuracy and stability in manipulating crystals in their crystallization drops were demonstrated. In particular, the invention significantly helped the harvesting of crystals stuck at the crystallization plate bottom. Crystals from 40 μm to 400 μm were manipulated and harvested successfully with the invention, even when grown in 96 well microplates in nano-drops.

The inventive system provided significant time reduction for the overall experiment, mainly because when using the robot, the harvested crystal is already mounted on the “goniometer” G-Rob and centered into the beam, thus ready for data collection. When using the manual method, the sample holder has to be transferred to the goniometer head, and the crystal centering operation is needed because the loop dimensions and the position of the crystal in the loop are random. This operation is typically very time consuming. As an example, in our experiment it took from one to two minutes per crystal. The robotic method brings a higher reliability and repeatability, facilitates harvesting of difficult crystals, and shows a time saving benefit when coupled to direct data collection. In addition to that, the crystals harvested using the invention coupled with a robotic arm were transferred with a reduced amount of mother liquid and cryo-protecting solution, as compared with crystals harvested with a loop. Therefore, no ice formation and reduced diffusion rings which induces a lower background in diffraction data- was observed with the inventive system in comparison with crystals on loop.

The present invention, when used in association with a robotic system, enables to remotely manage protein crystallography experiments, from crystallization assays to structure resolution. It also provides a novel and innovative method and means to further achieve complete high throughput automated pipelines for crystallography.

TABLE 1

| | |
|---|---|
| lysozyme | NikA-FeEDTA |

| Data set | Manual 1 | Manual 2 | Robotic 1 | Robotic 2 | Manual 1 | Manual 2 | Robotic 1 | Robotic 2 |
|---|---|---|---|---|---|---|---|---|
| Data collection | | | | | | | | |
| Wavelength | 0.97955 | 0.97955 | 0.9795 | 0.9797 | 0.97969 | 0.97968 | 0.97967 | 0.97967 |
| (Å) | | | | | | | | |
| Oscillation (°) | 1 | 1 | 1 | 1 | 1 | 1 | 1 | 1 |
| Range | 60 | 90 | 69 | 110 | 75 | 110 | 90 | 90 |
| Data reduction | | | | | | | | |
| Space group | P4₃2₁2 | P4₃2₁2 | P4₃2₁2 | P4₃2₁2 | P2₁2₁2₁ | P2₁2₁2₁ | P2₁2₁2₁ | P2₁2₁2₁ |
| Resolution | 38.65-1.50 | 36.78-1.80 | 38.62-1.75 | 38.99-1.60 | 47.01-2.65 | 40.70-1.85 | 44.25-2.30 | 44.22-1.95 |
| (last shell) (Å) | (1.58-1.50) | (1.90-1.80) | (1.84-1.75) | (1.69-1.60) | (2.75-2.65) | (1.95-1.85) | (2.40-2.30) | (2.05-1.95) |
| Completeness | 84.7 (88.7) | 100 (100) | 99.9 (100) | 99.7 (100) | 97.4 (98.3) | 97.9 (98.4) | 98.6 (98.6) | 97.3 (98.2) |
| (last shell) (%) | | | | | | | | |
| Reduction | | | | | | | | |
| Total | 4948 | 73949 | 59671 | 125316 | 90500 | 380011 | 163609 | 267767 |
| reflections | (11509) | (10330) | (8306) | (16597) | (9330) | (54747) | (19205) | (37037) |
| (last shell) | | | | | | | | |
| Unique | 15560 | 10887 | 11761 | 15436 | 29023 | 83913 | 44557 | 71555 |
| reflections | (2324) | (1548) | (1671) | (2201) | (3015) | (12171) | (5294) | (9924) |
| (last shell) | | | | | | | | |
| Redundancy | 5.5 (5.0) | 6.8 (6.7) | 5.1 (5.0) | 8.1 (7.5) | 3.1 (3.1) | 4.5 (4.5) | 3.7 (3.6) | 3.7 (3.7) |
| (last shell) | | | | | | | | |
| R_{sym}^{a} (last | 4.9 (37.9) | 5.5 (46.4) | 8.8 (42.0) | 5.8 (42.7) | 12.4 (39.2) | 4.7 (35.9) | 5.6 (33.5) | 5.3 (32.9) |
| shell) (%) | | | | | | | | |
| Rₚᵢₘ^{b} (last | 2.2 (18.2) | 2.3 (19.2) | 4.3 (20.7) | 2.2 (16.5) | 8.7 (26.1) | 2.6 (19.2) | 3.7 (20.7) | 3.5 (20.1) |
| shell) (%) | | | | | | | | |
| I/σ (last shell) | 17.2 (3.9) | 21.5 (4.1) | 10.8 (4.5) | 17.7 (3.8) | 7.34 (2.92) | 19.23 (4.40) | 16.68 (4.35) | 16.45 (4.51) |
| (I) | | | | | | | | |
| Mosaicity | 0.247 | 0.401 | 0.331 | 0.376 | 0.190 | 0.317 | 0.318 | 0.234 |
| Unit Cell (Å) | a = 77.31 | a = 77.51 | a = 77.30 | a = 77.98 | a = 86.28 | a = 86.24 | a = 86.24 | a = 86.33 |
| | b = 77.31 | b = 77.51 | b = 77.30 | b = 77.98 | b = 94.02 | b = 93.64 | b = 93.74 | b = 93.88 |
| | c = 36.97 | c = 36.78 | c = 36.89 | c = 36.71 | c = 123.3 | c = 123.2 | c = 123.4 | c = 123.1 |
| Refinement | | | | | | | | |
| Resolution | 38.65-1.50 | 34.66-1.80 | 34.57-1.75 | 33.21-1.60 | 47.01-2.65 | 40.70-1.85 | 40.71-2.30 | 43.17-1.95 |
| range (last | (1.59-1.50) | (1.89-1.80) | (1.84-1.75) | (1.65-1.60) | (2.74-2.65) | (1.87-1.85) | (2.35-2.30) | (1.98-1.95) |
| shell) (Å) | | | | | | | | |
| R_{work}^{c} (last | 18.16 (22.45) | 16.90 (21.34) | 16.25 (20.0) | 17.25 (21.72) | 17.40 (22.95) | 17.53 (27.20) | 18.51 (25.34) | 17.17 (25.63) |
| shell) (%) | | | | | | | | |
| R_{free}^{d} (last | 20.21 (25.77) | 21.61 (26.09) | 19.74 (27.11) | 19.37 (22.08) | 26.91 (33.81) | 21.55 (32.57) | 25.47 (35.85) | 21.65 (31.81) |
| shell) (%) | | | | | | | | |
| R.m.s.d bonds | 0.006 | 0.007 | 0.008 | 0.008 | 0.008 | 0.007 | 0.008 | 0.008 |
| (Å) | | | | | | | | |
| R.m.s.d angles | 1.063 | 1.062 | 1.187 | 1.125 | 1.150 | 1.124 | 1.087 | 1.117 |
| (°) | | | | | | | | |
| Reflections in | 15534 | 10856 | 11725 | 15394 | 29015 | 83910 | 44550 | 71549 |
| refinement | | | | | | | | |
| B factor | 19.1 | 26.6 | 21.9 | 25.1 | 32.94 | 30.23 | 41.51 | 30.04 |
| average (Å²) | | | | | | | | |

Data and Refinement Statistics. Comparison of dataset statistics for lysozyme and NikA-FeEDTA crystals harvested either manually (named “Manual 1” and “Manual 2”) or with the invention (named “Robotic 1” and “Robotic 2”).
^{a}R_{sym} = Σ|Iᵢ − </>|/ΣIᵢ where Iᵢ is the intensity of a reflection and </> is the average intensity of that reflection.
^{b}R_{pym} = (Σ(1/(n−1))Σ|Iᵢ − </>|)/Σ</>, where n is the number of observation of the reflection.
^{c}R_{work} = Σ||F_{obs}| − |F_{calc}||/Σ|F_{obs}|.
^{d}R_{free} is the same as R_{work} but calculated for 5% data omitted from the refinement.

TABLE 2

| | Comparative RMSD on main chain | | | | | | |
|---|---|---|---|---|---|---|---|
| | (Å) | | | | Volume changes (%) | | |
| Lysozyme | 1LZ8 | Manual 1 | Manual 2 | Robotic 1 | Manual 1 | Manual 2 | Robotic 1 |
| Manual 1 | 0.202 | — | — | — | — | — | — |
| Manual 2 | 0.259 | 0.162 | — | — | 0.00 | — | — |
| Robotic 1 | 0.223 | 0.083 | 0.123 | — | 0.24 | 0.24 | — |
| Robotic 2 | 0.246 | 0.181 | 0.090 | 0.156 | 1.03 | 1.02 | 1.27 |
| NikA-FeEDTA | 1ZLQ | Manual 1 | Manual 2 | Robotic 1 | Manual 1 | Manual 2 | Robotic 1 |
| Manual 1 | 0.321 | — | — | — | — | — | — |
| Manual 2 | 0.364 | 0.219 | — | — | 0.57 | — | — |
| Robotic 1 | 0.470 | 0.289 | 0.210 | — | 0.24 | 0.33 | — |
| Robotic 2 | 0.332 | 0.207 | 0.124 | 0.243 | 0.25 | 0.32 | 0.01 |

Unit Cell Changes between manually and robotically harvested crystals.

We claim:

1. A gripper comprising tweezers to harvest organic or biological samples inferior in size to 1 mm;

2. claim 1), said samples being macromolecule crystals;

3. claim 2), wherein said tweezers are made of soft ending elements such as, but not limited to polymer elements;

4. claim 3), wherein said soft elements are removable and attached to an actuator such as, but not limited to a piezoelectric, mechanical, or thermoelectric device;

5. a gripper comprising tweezers to harvest organic or biological samples inferior in size to 1 mm and mounted on a robotic arm;

6. claim 5), said samples being macromolecule crystals;

7. claim 6), wherein said tweezers are made of soft ending elements such as, but not limited to polymer elements;

8. claim 5), wherein said tweezers are made of soft ending elements such as, but not limited to polymer elements;

9. claim 6), wherein said soft elements are removable and attached to an actuator such as, but not limited to a piezoelectric, mechanical, or thermoelectric device;

10. A method to harvest organic or biological samples inferior in size to 1 mm, using a gripper comprising tweezers;

11. claim 10), said samples being macromolecule crystals;

12. claim 10), wherein said tweezers are made of soft ending elements such as, but not limited to polymer elements;

13. claim 10), said gripper being mounted on a robotic arm;

14. claim 10) said samples being kept in the tweezers for further steps such as preparation and analysis;

15. claim 14), said analysis being X-ray crystallography;

16. claim 11), wherein said tweezers are made of soft ending elements such as, but not limited to polymer elements;

17. claim 11), wherein said soft elements are removable and attached to an actuator such as, but not limited to a piezoelectric, mechanical, or thermoelectric device;

18. claim 11), said gripper being mounted on a robotic arm;

19. claim 11), said sample being kept in the tweezers for further steps such as preparation and analysis;

20. claim 19), said analysis being X-ray crystallography;
